(19) United States
(12) Patent Application Publication
(10) Pub. No.: US 2005/0050572 A1
(43) Pub. Date: Mar. 3, 2005

(54) Optical disc

(75) Inventors: Jong-tae An, Suwon-si (KR); Seong-yeon Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/829,386

(22) Filed: Apr. 22, 2004

(30) Foreign Application Priority Data
Apr. 23, 2003 (KR) 2003-25712

(51) Int. Cl. G11B 3/70

(52) U.S. Cl. 720/719; 720/722

(57) ABSTRACT

An optical disc having a structure by which the development of cracks near its center hole can be prevented includes a center hole and at least one sheet attached and surrounding the center hole, preventing the generation and development of cracks near the center hole.

### CROSS-REFERENCE TO RELATED APPLICATIONS

This application claims the benefit of Korean Patent Application No. 2003-25712, filed on Apr. 23, 2003, in the Korean Intellectual Property Office, the disclosure of which is incorporated herein by reference.

### BACKGROUND OF THE INVENTION

1. Field of the Invention

The present invention relates to an optical disc used as a recording and/or reproduction medium for an optical disc drive, and more particularly, to an optical disc having a structure by which the development of cracks near the center hole can be prevented.

2. Description of the Related Art

Referring to FIG. 1, an optical disc 10, such as a CD-ROM, a DVD-ROM, a CD-RW, a DVD-RW, etc., which is loaded into an optical disc drive, includes a clamping area 12, a lead-in area 13, which stores a data list, etc., and a data area 14 where actual data is recorded. A center hole 11 is formed at the center of the clamping area 12. The optical disc 10 has a thickness of 1.2 mm and an outer diameter of 120 mm or 80 mm. The center hole 11 has a diameter of 15 mm.

However, a problem of cracks generating near the center hole 11 in a radial direction arises with optical discs having such a structure. This is related to the use of a plastic molded product in a region surrounding the center hole 11 of the optical disc 10. This region is affected by shear force or bending force repeatedly applied when the optical disc is placed in a disc case 20, due to a fixing tension portion 21 of the disc case 20, as illustrated in FIG. 2.

Furthermore, a slim type optical disc drive adopted in, for example, a notebook computer has a clamping structure by which a force is exerted on a center region of a loaded optical disc, near the center hole 11, in a radial direction, as the fixing tension portion 21 does. Therefore, when the optical disc 10 is frequently used with such a slim type optical disc drive, it is more likely that cracks will develop near the center hole 11.

A more serious problem is that such cracks become larger as the optical disc is rotated. That is, minor cracks generated near the center hole 11 extend little by little in a radial direction as the optical disc is rotated at a high speed.

Due to the use of higher speed optical disc drives in recent years, it is more frequent that a disc be fatally damaged due to the development of minor cracks. Therefore, there is a need to prevent the development of cracks near the center hole 11 of the optical disc.

### SUMMARY OF THE INVENTION

The present invention provides an optical disc having a structure by which the development of cracks near a center hole can be effectively prevented.

According to an aspect of the present invention, there is provided an optical disc, for information recording and/or reproduction using light, having a center hole, the optical disc including at least one sheet attached to surround the center hole to prevent the generation and development of cracks near the center hole.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a conventional optical disc;

FIG. 2 is a perspective view illustrating the optical disc 1 of FIG. 1 placed in a disc case;

FIG. 3 is a perspective view of an optical disc according to an embodiment of the present invention;

FIG. 4 is a partial sectional view of the optical disc shown in FIG. 3; and

FIG. 5 is a partial sectional view of an optical disc according to another embodiment of the present invention.

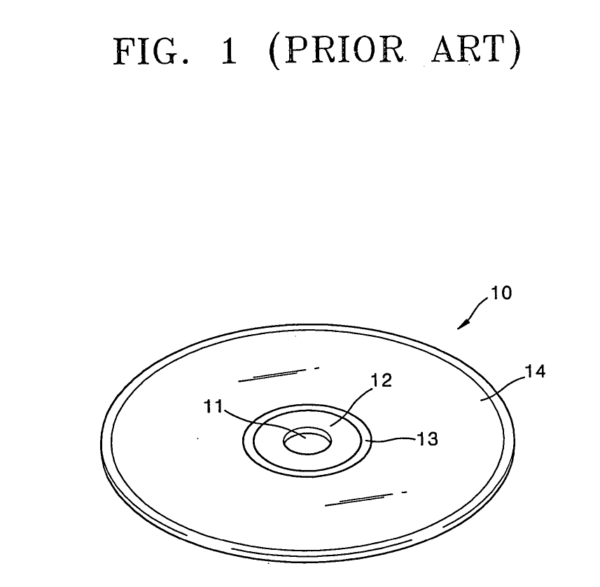

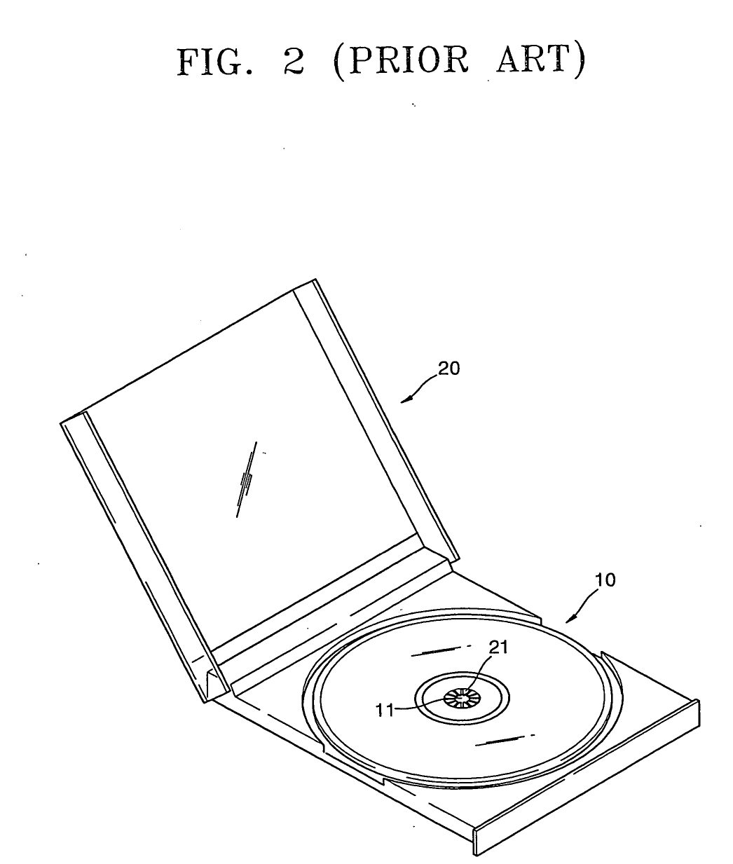

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

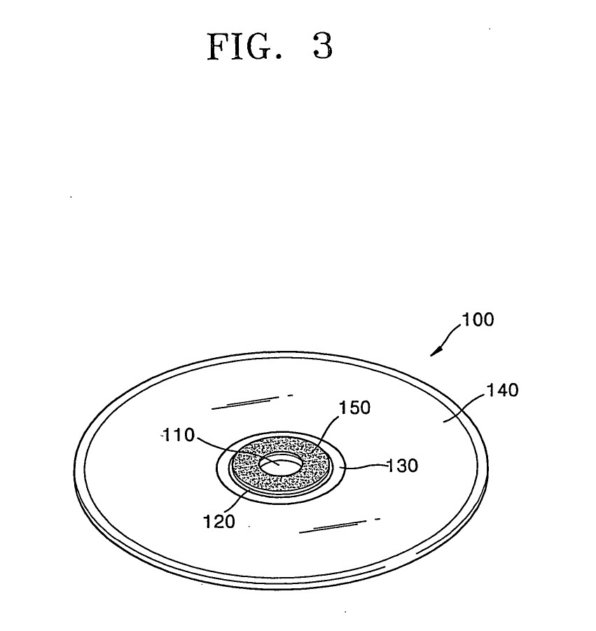

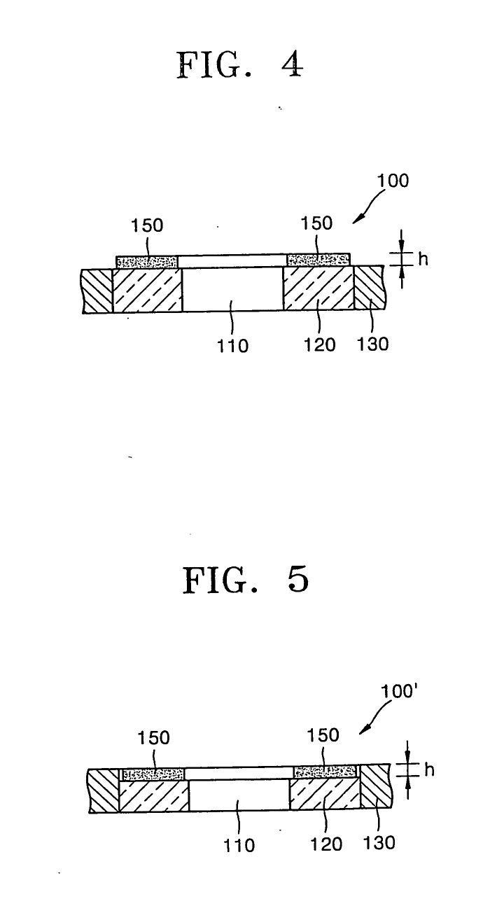

Referring to FIGS. 3 and 4, an optical disc 100 according to an embodiment of the present invention has a center hole 110 and at least one sheet 150 attached and surrounding the center hole 110. Due to this structure, generation of cracks near the center hole 110 and development of cracks thereof can be prevented.

In particular, the optical disc 100 is divided into a clamping area 120, a lead-in area 130, and a data area 140. The center hole 110 is formed at the center of the clamping area 120. According to optical discs standards, the optical disc 110 has a thickness of 1.2 mm and an outer diameter of 120 mm or 80 mm. The center hole 110 has a diameter of 15 mm.

The sheet 150 may be located in the clamping area 120 to prevent the development of cracks formed near the center hole 110. The sheet 150 is made of paper or other frictional flexible materials. The sheet 150 may be attached to the clamping area 120 using an adhesive or a double-sided tape. The sheet 150 has an annular shape to surround the center hole 110.

By attaching the sheet 150 to the clamping area 120, the development of cracks formed near the center hole 110 in a radial direction can be prevented. In other words, due to the adhesion of the sheet 150 to the clamping area 120, the development of cracks towards an outer perimeter of the optical disc 110 can be prevented.

Even if minor cracking is inevitable, the sheet 150 can effectively prevent further development of the cracks and fatal damage to the optical disc.

In an embodiment according to the present invention, a height h of the sheet 150, which protrudes above the optical disc 100, including a thickness of an adhesive applied thereto, may be no greater than 0.3 mm. This height range of the sheet 150 is determined in consideration of clamping stability at a high rotation speed.

FIG. 5 is a partial sectional view illustrating main portions of an optical disc 100′ according to another embodiment of the present invention. Referring to FIG. 5, to enhance clamping stability in addition to preventing the development of cracks, the clamping area 120 is recessed by a depth, which may be equal to or greater than the thickness of the sheet 150 to be attached thereto, such that the sheet 150 attached thereto does not protrude above a top surface of the optical disc 100′. As a result, the optical disc 100′ has a planar, smooth top surface. The optical disc 100′ can be more stably clamped.

As described above, an optical disc according to the present invention has a sheet-attached clamping area so that the development of cracks near its center hole and further fatal damage to the optical disc can be effectively prevented due to the sheet attached to the clamping area. When the clamping area is recessed such that the sheet attached thereto does not protrude above an upper surface of the optical disc, more stable clamping is ensured.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An optical disc, for information recording and/or reproduction using light, having a center hole, the optical disc comprising at least one sheet attached and surrounding the center hole to prevent generation and development of cracks near the center hole.

2. The optical disc of claim 1, wherein the sheet has an annular shape.

3. The optical disc of claim 1, wherein the disc is divided into a clamping area adjacent to the center hole, a data area in which data is recorded, and a lead-in area between the clamping area and the data area, wherein the at least one sheet is attached to the clamping area.

4. The optical disc of claim 3, wherein the clamping area is recessed such that a surface of the sheet attached to the clamping area is leveled with or lower than a surface of the lead-in area.

5. The optical disc of claim 3, wherein the sheet has an annular shape.

6. The optical disc of claim 1, wherein the sheet is of paper or other frictional flexible materials.

7. The optical disc of claim 3, wherein the sheet is attached to the clamping area using an adhesive or a double-sided tape.

8. The optical disc of claim 3, wherein the clamping area is recessed by a depth equal to or greater than a thickness of the sheet.

9. The optical disc of claim 1, wherein the sheet does not protrude above a top surface of the optical disc.

10. The optical disc of claim 8, wherein the sheet does not protrude above a top surface of the optical disc.

11. An optical disc comprising a material attached and surrounding a center hole of the optical disc, preventing generation and development of cracks near the center hole.

12. The optical disc of claim 11, wherein the material has an annular shape.

13. The optical disc of claim 11, wherein the disc is divided into a clamping area adjacent to the center hole, a data area in which data is recorded, and a lead-in area between the clamping area and the data area, wherein the material is attached to the clamping area.

14. The optical disc of claim 13, wherein the clamping area is recessed such that a surface of the material attached to the clamping area is leveled with or lower than a surface of the lead-in area.

15. The optical disc of claim 13, wherein the material has an annular shape.

16. The optical disc of claim 11, wherein the material is paper or other frictional flexible materials.

17. The optical disc of claim 13, wherein the material is attached to the clamping area using an adhesive or a double-sided tape.

18. The optical disc of claim 13, wherein the clamping area is recessed by a depth equal to or greater than a thickness of the material.

19. The optical disc of claim 11, wherein the material does not protrude above a top surface of the optical disc.

20. The optical disc of claim 18, wherein the material does not protrude above a top surface of the optical disc.
